(19) United States
(12) Patent Application Publication
(10) Pub. No.: US 2020/0356925 A1
(43) Pub. Date: Nov. 12, 2020

(54) SYSTEM AND METHOD FOR MEASURING BRAND VITALITY

(71) Applicant: Traackr, Inc., San Francisco, CA (US)

(72) Inventors: Eva Papadimitriou, San Francisco, CA (US); Mikaël Gravé, Ottawa (CA); Nicolas Chabot, Paris (FR)

(21) Appl. No.: 16/871,356

(22) Filed: May 11, 2020

Related U.S. Application Data
(60) Provisional application No. 62/846,098, filed on May 10, 2019.

(51) Int. Cl. G06Q 10/06; G06Q 50/00; G06Q 30/02; G06Q 10/10; H04L 29/08

(52) U.S. Cl. CPC G06Q 10/0637; G06Q 50/01; G06Q 30/0272; G06Q 30/0246; G06N 20/00; G06Q 30/0201; G06Q 30/0282; G06Q 30/0204; H04L 67/22; G06Q 10/10

(57) ABSTRACT

Systems and computer-implemented methods provided herein determine a metric for brand vitality (VIT) for social media content. VIT is a unique score for each post of social media content that acts as a proxy for impact on consumers. By avoiding the need to conduct costly consumer research for each brand or marketing campaign on social media, the determination of VIT provides a cost-effective and automated yet still meaningful assessment of the reach and exposure of the brand or marketing campaign. Importantly, the determination of VIT is scalable in a way that polling and consumer research is not.

### RELATED APPLICATIONS

This application claims priority to U.S. Provisional Application No. 62/846,098, filed May 10, 2019, the entire contents of the above application being incorporated herein by reference.

### BACKGROUND

The share of total consumer activity conducted online continues to increase and marketers are expanding their portfolio to include advertising through online channels such as social media networks. These marketing efforts include posts by social media influencers mentioning one or more brands that are aimed at attracting the attention of their followers to the brands.

### SUMMARY

In accordance with some embodiments of the present disclosure, a computing-device implemented method of determining a metric for brand vitality (VIT) for social media content is presented. The method includes identifying one or more visibility attributes associated with a post of social media content on a channel for delivering social media. The one or more visibility attributes measure visibility of the post to users of the channel. The method also includes identifying one or more engagement attributes associated with the post of social media content on the channel. The one or more engagement attributes measure engagement with the post by users of the channel. The method further includes identifying one or more trust attributes associated with the post of social media content on the channel. The one or more trust attributes measure brand association of the post. The method additionally includes generating a VIT score for the post of social media content using the one or more visibility attributes, the one or more engagement attributes, and the one or more trust attributes.

In accordance with some embodiments of the present disclosure, a non-transitory medium holding computer-executable instructions for determining a metric for brand vitality for social media content is presented. When executed, the instructions cause at least one computing device to identify one or more visibility attributes associated with a post of social media content on a channel for delivering social media. The one or more visibility attributes measure visibility of the post to users of the channel. Execution of the instructions also causes the at least one computing device to identify one or more engagement attributes associated with the post of social media content on the channel. The one or more engagement attributes measure engagement with the post by users of the channel. Execution of the instructions further causes the at least one computing device to identify one or more trust attributes associated with the post of social media content on the channel. The one or more trust attributes measure a brand association of the post. Execution of the instructions additionally causes the at least one computing device to generate a VIT score for the post of social media content using the one or more visibility attributes, the one or more engagement attributes, and the one or more trust attributes.

In accordance with some embodiments of the present disclosure, a system for determining a metric for brand vitality for social media content is presented. The system includes a computing device including a processor and a memory operatively coupled to the processor. The memory has instructions stored therein that, when executed by the processor, cause the computing device to identify one or more visibility attributes associated with a post of social media content on a channel for delivering social media. The one or more visibility attributes measure visibility of the post to users of the channel. Execution of the instructions further causes the computing device to identify one or more engagement attributes associated with the post of social media content on the channel. The one or more engagement attributes measure engagement with the post by users of the channel. Execution of the instructions further also causes the computing device to identify one or more trust attributes associated with the post of social media content on the channel. The one or more trust attributes measure a brand association of the post. Execution of the instructions additionally causes the computing device to generate a VIT score for the post of social media content using the one or more visibility attributes, the one or more engagement attributes, and the one or more trust attributes.

### BRIEF DESCRIPTION OF THE DRAWINGS

The skilled artisan will understand that the drawings are primarily for illustrative purposes and are not intended to limit the scope of the subject matter described herein. The drawings are not necessarily to scale; in some instances, various aspects of the subject matter disclosed herein may be exaggerated or enlarged in the drawings to facilitate an understanding of different features. In the drawings, like reference characters generally refer to like features (e.g., functionally similar or structurally similar elements).

The foregoing and other features and advantages provided by the present disclosure will be more fully understood from the following description of exemplary embodiments when read together with the accompanying drawings, in which:

FIG. 1 depicts factors utilized in generating a brand vitality (VIT) score;

FIG. 2 is a flowchart of a sequence of steps for determining a VIT score for a post of social media content in an exemplary embodiment;

FIG. 3 illustrates a flowchart of a sequence of steps showing optional adjustments related to the author of a social media post that can be made to the result obtained in FIG. 2 in an exemplary embodiment;

FIG. 4 illustrates a method of generating a total brand vitality (total VIT) score for a marketing campaign in an exemplary embodiment;

FIG. 5 is a flowchart of a sequence of steps for determining the VIT score for the post of social media content in an exemplary embodiment;

FIG. 6 is a flowchart of a sequence of steps for further optional adjustment of the VIT score from FIG. 5 in an exemplary embodiment;

FIG. 7 illustrates an exemplary plot of web traffic versus VIT score as generated for a group of posts of social media content;

FIG. 8 illustrates an exemplary plot of search volume using the Google® search engine for key terms related to a brand vs. VIT scores for a group of posts of social media content related to that brand;

FIG. 9 illustrates a plot of owned engagement vs. VIT score for a group of posts of social media content;

FIG. 10 is a block diagram of a computing device suitable for implementing exemplary embodiments of the present disclosure;

FIG. 11 is a block diagram of a distributed environment suitable for use in accordance with exemplary embodiments of the present disclosure.

FIG. 12 illustrates a graphical user interface (GUI) displaying total VIT information calculated for several brands in accordance with various embodiments described herein.

### DETAILED DESCRIPTION

Existing metrics and methods for measuring marketing impact in online communications can provide misleading or incorrect results. For example, the Earned Media Value (EMV) statistic has been used to attempt to provide a dollar value for “earned” social media content. In other words, EMV provides each post of social media content with a dollar value demonstrating its “worth” to the marketer. In many ways, EMV is an online version of the concept of Advertising Value Equivalents (AVE), which has long existed as an attempt to provide a cost equivalent to buying that medium or reach through advertising. However, EMV and AVE are widely acknowledged to be flawed and the public relations industry has debunked or invalidated the effectiveness of these measures. Notably, knowledgeable marketers realize that authentic brand recommendations from trusted individuals carry significantly more weight than a simple advertisement and, thus, online marketing is not adequately served by old measures arising from the pre-digital world. Moreover, the dollar value is very misleading as it has no connection to ultimate return on investment (ROI) or sales. In addition, the dollar value provided by EMV bears no serious relation to actual prices for online placement as the fees charged by, e.g., an influencer to advertise a product can vary significantly based upon personal factors such as how much the influencer wants to work with the brand, what the campaign is, and other intangible factors representing what he or she stands to gain.

Although calculations of EMV are not standardized across companies, the calculation of EMV is based on purely quantitative measures without regard for important additional information that can be equally important in judging the marketing success of a post or campaign. For example, EMV doesn't take into account the sentiment of a post, mentions of competitors in a post, or whether the marketer's key messages are present in a post. A social media post including a negative review of the marketer's product may be given a high EMV score if it reaches many consumers but would clearly be undesirable from the marketer's point of view. In addition, EMV doesn't take into account whether the post or campaign reaches target audiences. Accordingly, EMV provides a poor metric for evaluating social media content.

Another conventional method for determining brand visibility is to perform a full market study. However, this method requires many human-hours of research and development to come to a final conclusion. As a consequence, results are very expensive and slow to obtain and cannot be easily maintained in an up-to-date status over time.

Systems and computer implemented methods provided herein determine a metric for brand vitality (VIT) for social media content. As further described herein, VIT is a unique score for each post of social media content that acts as a proxy for the post's impact on consumers. By avoiding the need to conduct costly consumer research for each brand or marketing campaign on social media, the determination of VIT provides a cost-effective and automated yet still meaningful assessment of the reach and exposure of the brand or marketing campaign. Importantly, the determination of VIT is scalable in a way that polling and consumer research is not. For example, VIT can be determined for every post of social media whereas consumer research is limited in scope as to how many posts of social media content can be included in the survey.

In one embodiment, the determination of VIT for the post of social media content is based on a combination of factors that includes a determination of visibility, engagement, and trust factors related to the post. Visibility measures raw views and effective reach. Engagement measures the amount of interest the content generates online. Trust factors in a VIT determination attempt to measure the brand association of the social media post. Entities in charge of branding want post authors (e.g., social media influencers) to publish content that fits the brand's image. By including all three factors in the determination of VIT, accurate assessments of the overall impact of the post of social media content among a target group of consumers may be determined. VIT evaluates aspects of the post of social media content beyond views including brand association of the post and, optionally, quality of the post author or author's audience. By incorporating an evaluation of trust attributes into the generation of VIT, the determined VIT score more accurately reflects the actual value of the post to the brand or marketer by avoiding unintentionally high valuation of posts having negative sentiment. Additionally, the determination of VIT can be actively performed for all or almost all posts of social media content in real-time thus providing an ability to perform ongoing monitoring of a marketing campaign and dynamic evaluation of social media influencers.

In some embodiments, the VIT scores for multiple unique pieces of social media content can be combined to generate a total VIT score. The total VIT score can reflect the reach and impact of a brand, product category, market, or particular post author (e.g., influencer). Thus, the determination of VIT is not tied to any single market or product type. As such, evaluations of VIT across markets (i.e., among brands or marketers with disparate product offerings) is possible. Because VIT can be compared among brands or marketers, total VIT facilitates brand rankings, benchmarking, and indexing. Total VIT provides a way to look at a market and compare the visibility and outreach of brands and products on social media.

Systems and methods described herein provide marketers with reliable information as to the relative success of social media posts or online marketing campaigns. By determining brand vitality, quantitative measures of engagement and visibility are combined with and modified by qualitative and quantitative trust attributes to provide a reliable measure of success in delivering a message to an intended audience.

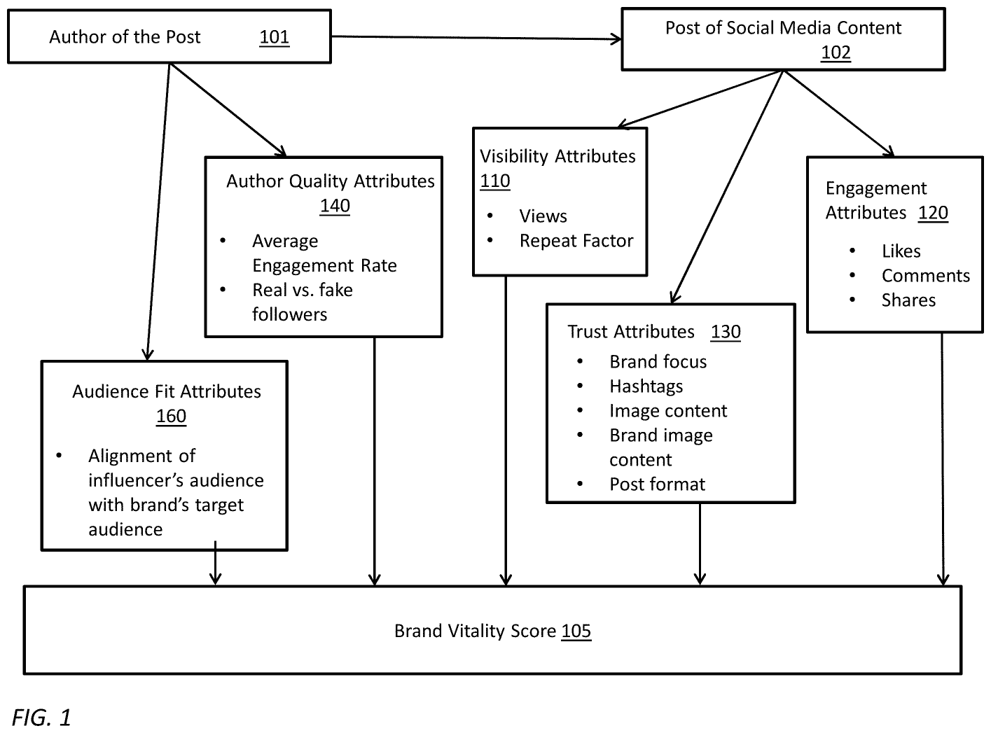

FIG. 1 depicts factors utilized in generating a brand vitality (VIT) score in an exemplary embodiment. More particularly, FIG. 1 shows the factors used by a computing device-executed VIT determination module to generate a brand vitality (VIT) score 105. The factors include factors related to a post of social media content 102, and factors related to an author of the post 101. The post of social media content 102 can include text, audio, video, or other multimedia content. The author of the post 101 authors the post of social media content 102 on a channel for delivering social media. As used herein, “channel” is defined as a service that facilitates online communication between users on either a one-to-one basis or a one-to-many basis. Exemplary channels include Facebook™, Twitter™, Twitch™, Pinterest™, blogs, and/or other social media services. In some embodiments, users may follow other users to receive new posts of social media content authored by the user. Users, including the author of the post 101, can interact with the channel through a website, through a dedicated application such as a phone app, or via other technological means.

The VIT determination module identifies one or more visibility attributes 110, one or more engagement attributes 120, and one or more trust attributes 130 that are associated with the post of social media content 102. The one or more visibility attributes 110 measure the visibility of the post to users of the channel. The one or more engagement attributes 120 measure engagement with the post of social media content 102 by users of the channel. The one or more trust attributes 130 measure brand association of the post of social media content 102. The visibility attributes 110, engagement attributes 120, and trust attributes 130 are discussed further below. Additionally when determining VIT, optional attributes related to the post may also be taken into consideration by the VIT determination module and used to adjust the generated VIT score. For example, in one embodiment, one or more author quality attributes 140 and/or one or more audience fit attributes 160 can be associated with the post author 101. In one embodiment, at least some of the data associated with the visibility attributes 110, engagement attributes 120, trust attributes 130, author quality attributes 140 and/or one or more audience fit attributes 160 are programmatically retrieved over a network by the VIT determination module from data made available from the social media channel and/or third party sources. In some embodiments at least some of the data associated with the visibility attributes 110, engagement attributes 120, trust attributes 130, author quality attributes 140 and/or one or more audience fit attributes 160 is stored information retrieved from databases accessible to the determination module. As explained further below, the VIT score 105 is generated for the post of social media content 102 using the one or more visibility attributes 110, the one or more engagement attributes 120, and the one or more trust attributes 130 (and optionally attributes related to the post author and/or audience). Because the generation of the VIT score uses the combination of visibility attributes, engagement attributes, and trust attributes, the VIT score 105 accurately provides a thorough measure of the marketing impact of the post of social media content 102 on relevant consumers.

The visibility attributes 110 relate to how widely viewed the post of social media content 102 is on the channel. In some embodiments, the visibility attributes can include a total number of views. In some embodiments, the total number of views can be modified by a repeat factor. The repeat factor accounts for the fact that the value of a post of social media content as part of a marketing campaign can be affected by the frequency at which the message is seen. For example, a post author 101 who repeats a marketing message too frequently among multiple posts of social media content 102 can dilute the message or lessen consumer perception of the authenticity of the message from that post author 101. This negative affect induced in consumer perception as to the authenticity of the message reduces, in turn, the impact of the message. This reduction in impact is reflected in a modulation of the visibility attributes by the repeat factor that causes a reduction in VIT score 105. In some embodiments, the repeat factor can be a function of the number of posts of social media content that include a same or similar marketing message and the time interval between the posts. In other words, the repeat factor is indicative of the number of times a brand is mentioned in posts by the same author over a pre-determined period of time in some embodiments.

The engagement attributes 120 relate to the frequency and degree to which users of the channel engaged with the post of social media content 102. In some embodiments, the engagement attributes 120 can include a number of likes, number of comments, or number of shares. In this context, a “like” refers to one of a number of devices provided by the channel that enable a user to indicate binary affect or interaction with the post of social media content 102. In some embodiments, a user can like the post of social media content 102 by clicking a button in a graphical user interface of the channel (e.g., a checkmark, smiley face, heart, star, or other symbol) to indicate that they appreciate the post of social media content 102 in some way. Although likes are often positive, some embodiments of the present disclosure include other indications of affect toward a post that include dislike, surprise, sadness, or other emotions. A comment refers to user interaction where the user provides customized input associated with the post of social media content 102. For example, the user can provide a comment in the form of text or an image. A share refers to an action taken by a user to direct the attention of their own followers to the original post of social media content 102. For example, the user may click a share button on the graphical user interface of the channel to cause the post of social media content 102 to appear in their own feed or stream.

In some embodiments, different engagement attributes 120 can be weighted differently in the determination of VIT score 105. This weighting can be accomplished by adjusting the engagement attribute 120 by a weighting factor based on pre-determined criteria. Formulation of a comment may require more effort on the user's part than simply clicking the “like” button on the graphical user interface. Therefore, comments may be weighted more heavily than likes in some embodiments under the rationale that the user has engaged more fully with the post of social media content 102 and, thus, the impact of the message in the post of social media content 102 on that user is greater. For example, a “like” of a post on Twitter may be worth a normalized weight of 1. From this baseline, other engagements may be given proportionally more weight, e.g., a share of a Twitter post may have a weight of 2, a share of a blog post may have a weight of 15, a comment on a blog post may have a weight of 30, and a comment on a Twitch stream may have a weight of 1. In one embodiment, the values of the weights assigned to the different engagement attributes may be calculated with the aid of machine learning analyzing past social media data.

Trust attributes 130 can provide an assessment of the brand association of the post of social media content 102 as well as the alignment between the message of the post of social media content 102 and the intended message of the marketer. In some embodiments, trust attributes 130 can include a brand focus, a presence of hashtags, overall image content, a brand image content, sentiment analysis, and a format of the post of social media content 102. Brand focus represents a measure of whether the post of social media 102 mentions solely the brand of the marketer. When the post of social media content 102 mentions only a sole brand, the post of social media content 102 is more focused which leads to a greater level of brand association. Overall image content can include several measures related to the presence of multimedia aspects in the post of social media content 102. If the post of social media content 102 includes an image or other form of multimedia (e.g., video or audio), the impact of the post of social media content upon users is greater. Brand image content refers to whether an image or multimedia component of the post of social media content 102, if present, includes images of brand logos, audio related to the brand (such as a catchphrase, slogan, or jingle) or other relevant properties. By including brand content in images or other multimedia, the impact of the post of social media content on the user with respect to the marketer's brand is increased. Format of the post of social media content 102 also plays a role in determining impact of the post upon the user. For example, if the post of social media content 102 provides only a photo-tag mention of the message or brand of the marketer, the brand association of the post could be lessened by the VIT generation module as the impact of the post on the user is reduced because the user is less likely to see the brand mention in a photo-tag than in the standard text of a post.

In some embodiments, trust attributes 130 can be provided in different formats for use in determining VIT score 105. The trust attributes 130 can be provided as binary values, discrete values or continuous values in a bounded set, or discrete values or continuous values in an unbounded set. The trust attribute 130 can be a grade assigned by a human or machine in some embodiments. In some embodiments, trust attributes 130 can be assessed heuristically by machine evaluation using, e.g., machine learning techniques.

While visibility attributes 110, engagement attributes 120, and trust attributes 130 are associated with the post of social media content 102, other categories of attributes are associated with the post author 101. In some embodiments, one or more author quality attributes 140 or one or more audience fit attributes 160 can be associated with the post author 101. The VIT score 105 can optionally be generated using the one or more author quality attributes 140 and/or the one or more audience fit attributes 160. By using author quality attributes 140 and/or audience fit attributes 160 in the determination of VIT score 105, the value of the VIT score 105 reflects how well aligned the author (and by extension, the author's audience) is with the goals of the marketer that sponsors the post of social media content 102. As a result, the VIT score 105 can capture more nuanced information such as how well the marketer's message is reaching a particular audience (e.g., a demographic group) and the relative effectiveness of a given post author 101 with respect to other post authors 101.

The author quality attributes 140 can include author behavior, average engagement rate, and the proportion of real to fake followers. In some embodiments, author behavior can include an objective ranking or evaluation of aspects of the author's posting behavior. For example, if the post author 101 has been scandalized by antisocial, spammy, or aggressive online (or real world) behavior, that criteria may be considered by the VIT determination module so that the post author 101 would rate poorly in author behavior. More specifically, in some embodiments, the average engagement rate can be expressed as the number of one or more engagement attributes (e.g., likes, comments, shares, or some combination of these attributes) that are garnered by each post of social media content 102 by that post author 101 divided by the total number of posts of social media content 102 by that post author 101. In some embodiments, the proportion of real to fake followers can be expressed as a ratio of real followers to fake followers, a ratio of fake followers to total followers, or some other proportional relationship among the number of real followers, number of fake followers, and total number of followers. Fake followers are a concern for marketers that use post authors 101 to deliver marketing messages because they can deceptively inflate the apparent reach of the post author despite the fact that many of the post author's followers are not relevant consumers or even human (e.g. they may be bots). The number of fake followers can be determined in some embodiments using detailed examinations of follower or relationship data or pattern analysis using, for example, a machine learning algorithm. In some embodiments, the author quality attributes 140 could contribute to generation of an author quality score on a scale from 0% to 100%. In some embodiments, the author quality score can be generated by combination of a mix of automated and semi-automated data sources. For example, automated data sources could be a count of number of followers of the author, ratios of comments to likes on author posts, or sudden spikes (or drops) in follower growth. Semi-automated data sources can include detection of past use of spammy or harsh language by the post author. Because semi-automated data sources can have a subjective element, human verification of the data may be employed in some embodiments.

The audience fit attributes 160 relates to the alignment between the post author's audience and the marketer's intended target audience and measure a quality of an audience of the post of social media content 102 on the social media channel. Relevant audience fit attributes 160 can include audience demographics and audience psychographics. Determining audience demographics can involve an assessment of the ages, genders, or other personal qualities of followers of the post author 101 based on data retrieved by the VIT determination module. Determining audience psychographics can involve an assessment of values, opinions, attitudes, interests, or lifestyles of followers of the post author 101. For example, a marketer of certain products may wish to target male individuals between 18-30 years old with an interest in surfing. A post author 101 who has many followers that fit those particular audience demographics (male, age 18-30) and audience psychographics (interest in surfing) as measured in retrieved data would have a strong alignment with the marketer's target, and a post of social media content 102 by such a post author 101 will have a higher VIT score 105 to reflect that alignment. In some embodiments, the audience fit attributes 160 can be used to generate an audience fit score. For example, audience analysis can be employed to generate an analysis of the audience for the author's posts. The distance can then be measured between the author's audience and the target audience defined for the VIT calculation (e.g., the target audience may be females between the ages of 18-30 living in the United Kingdom and having a strong interest in fitness). The distance can then be normalized to a value on a 0-100% scale.

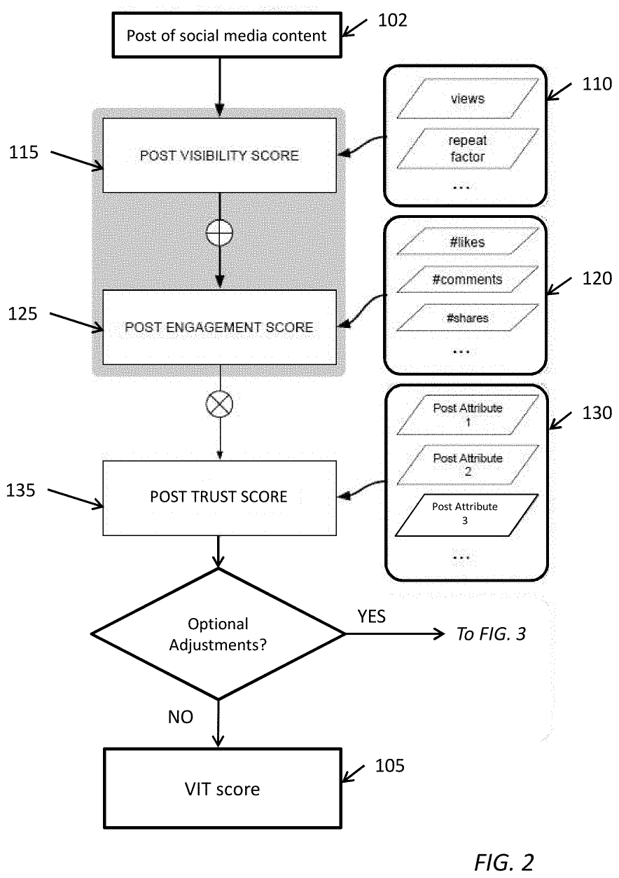

FIG. 2 is a flowchart of a sequence of steps for determining a VIT score for a post of social media content 102 in an exemplary embodiment. It will be appreciated that the steps of the VIT score determination are performed at least in part by one or more computing devices executing the instructions of a VIT determination module to perform the operations described herein. The VIT score determination begins when attributes of a post of social media content 102 are retrieved and analyzed by the VIT determination module to produce related numerical scores that can be manipulated and combined to arrive at the final VIT score 105. The visibility attributes 110 of the post of social media content 102 contribute to a post visibility score 115 and may be retrieved from the social media channel/platform on which the post appears, third party monitoring sources that provide data regarding operational metrics of the social media channel/platform and/or stored information in databases accessible to the VIT determination module. In some embodiments, the post visibility score 115 can be the raw number of views or the number of views modified by the repeat factor. When the number of views is not public or is otherwise unavailable, the number of views can be estimated using statistical techniques.

The engagement attributes 120 of the post of social media content 102 are also identified by the VIT determination module and contribute to a post engagement score 125. The engagement attributes 120 may be retrieved from the social media channel/platform on which the post appears, third party monitoring sources that provide data regarding operational metrics of the social media channel/platform and/or stored information in databases accessible to the VIT determination module. In some embodiments, the post engagement score 125 can include a combination of several engagement attributes (e.g., likes, comments, or shares) that are independently weighted (i.e., scaled) and summed and/or multiplied together. Alternatively, the post engagement score 135 can be determined categorically wherein the presence or magnitude of certain engagement attributes 120 places the post of social media content 102 into a specific category carrying a pre-defined post engagement score 125. Similarly, the VIT determination module identifies the trust attributes 130 of the post of social media content 102 that contribute to a post trust score 135 and may be retrieved from the social media channel/platform on which the post appears, third party monitoring sources that provide data regarding operational metrics of the social media channel/platform and/or stored information in databases accessible to the VIT determination module. The post trust score 135 can include a combination of several trust attributes that are independently weighted (i.e., scaled) and summed or multiplied together. Alternatively, the post trust score 135 can be determined categorically wherein the presence or magnitude of certain trust attributes 130 places the post of social media content 102 into a specific category carrying a pre-defined post trust score 135.

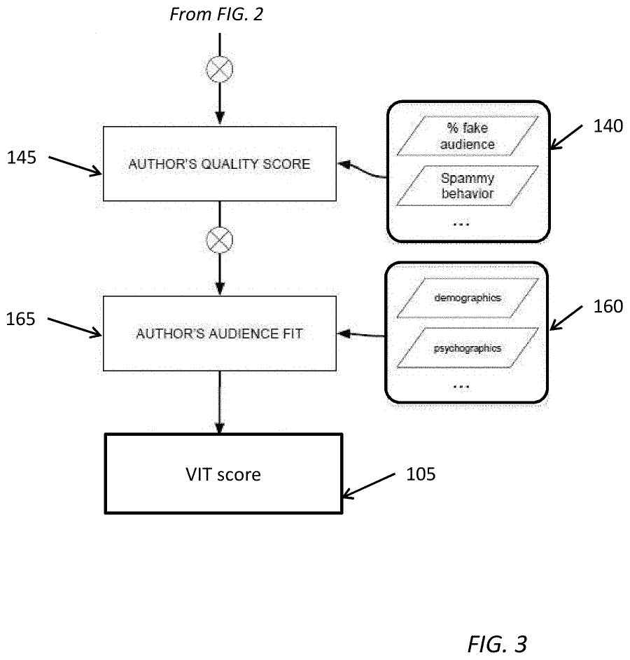

In some embodiments, the post visibility score 115 and the post engagement score 125 are summed by the VIT determination module. In some embodiments, the result of the summation of the post visibility score 115 and the post engagement score 125 is multiplied by the post trust score 135 by the VIT determination module. The result value after the multiplication can optionally be refined further by the VIT determination module using optional adjustments related to the post author 101 as described in greater detail in FIG. 3. If no optional adjustments are desired, the result of the multiplication is the VIT score 105.

FIG. 3 illustrates a flowchart of a sequence of steps showing optional adjustments related to the author of a social media post that can be made by the VIT determination module to the result obtained in FIG. 2 in an exemplary embodiment. In one embodiment, the initial VIT score resulting from the multiplying the summed visibility and engagement scores by the trust score can be adjusted by an author's quality score 145 derived from the author's quality attributes 140. For example, the result of the multiplication can itself be multiplied by the author's quality score 145. In another embodiment, another optional adjustment can be made based on an author's audience fit score 165 derived from the one or more audience fit attributes 160. In various embodiments, the result of the multiplication in FIG. 2 can be adjusted by either the author quality score 145 or the author's audience fit score 165, or by both scores.

In some contexts it is useful to determine whether one post author 101 tends to have greater VIT scores 105 than other post authors 101. If a post author 101 is identified by a marketer as an author that has higher VIT scores 105 than others, a greater proportion of resources can be directed to that post author 101 to improve marketing outcomes and drive sales. One way to assess the value of a post author 101 to a particular marketer is to determine an average VIT score 105 for posts of social media content 102 authored by that post author 101. In some embodiments, the posts of social media content 102 by a single post author 101 can relate to one brand, multiple brands, one marketing campaign, or multiple marketing campaigns. The posts of social media content 102 by the post author 101 can be limited to posts made during a period of time or can include every post of social media content 102 made by that post author 101.

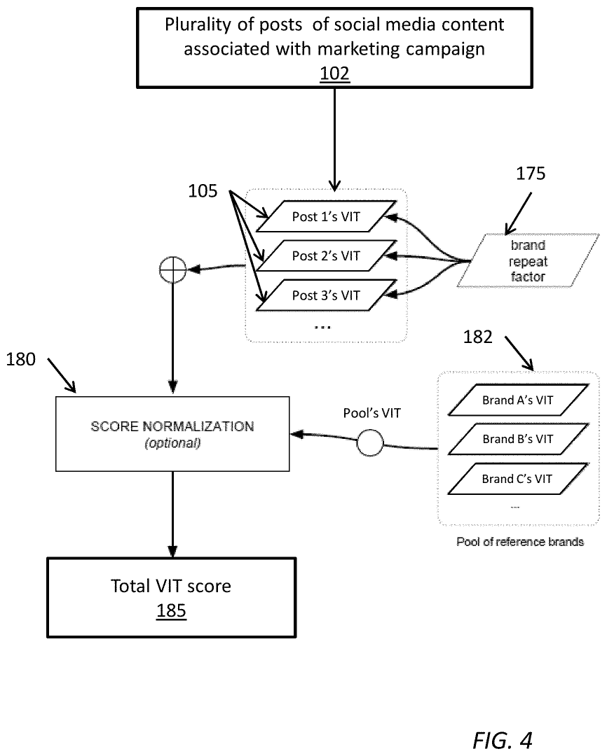

FIG. 4 illustrates a method of generating a total VIT score 185 for a marketing campaign in an exemplary embodiment. The total VIT score 185 is based on the individual VIT scores 105 generated for multiple posts of social media content 105 that are all associated with the marketing campaign. In some embodiments, the multiple posts of social media content 102 that are evaluated can appear across different social media channels (e.g., a first post of social media content 102 appears on a first channel and a second post of social media content appears on a second channel). In some embodiments, a brand repeat factor 175 is applied to the VIT scores 105 for the multiple posts of social media content 102. The brand repeat factor 175 can deflate the total VIT score 185. In other words, no repetition of posts affords each post the full complement of views when calculating VIT, but repetition can lessen the number of views used the VIT calculation for each post due to consumer fatigue. At the brand level, repeat factor 175 can be assessed across all posts of social media content 102 that discuss that brand.

After application of the brand repeat factor 175, the VIT scores 105 for each of the multiple posts of social media content 102 can be summed together by the VIT determination module in some embodiments. This summation produces a raw, unscaled value for total VIT score 185. Optionally, score normalization 185 can then be performed to produce a normalized (scaled) value for total VIT score 185. In one embodiment, to normalize the raw total VIT score 185, one or more raw total VIT scores 182 are gathered or determined for competitor or reference brands. These competitor or reference brands can be brands that compete in the same market or use similar products as the marketer for whom the normalized total VIT score 185 is being generated. The multiple competitor total VIT scores 182 and the raw total VIT score 185 are pooled and normalized relative to one another. In some embodiments, the highest score in the pooled total VIT scores can be given a normalized total VIT score of 1 and the other scores in the pool can be given a normalized total VIT score representing the ratio of the raw total VIT score to the highest score. In some embodiments, the mean, median, or mode value of raw total VIT score from among the pool of scores can be determined, and each individual normalized total VIT score 185 can be scaled to that mean, median, or mode value. By normalizing the total VIT score 185 against competitors, the import of changes in total VIT score 185 over the course of a marketing campaign or over time can be more meaningful because they provide a yardstick against which the score can be measured and appreciated. In some embodiments, a brand ranking can be generated based on the total VIT score 185 determined from one or more posts of social media content 102 associated with a first brand and one or more total VIT scores 182 determined from one or more posts of social media content 102 associated with different brands.

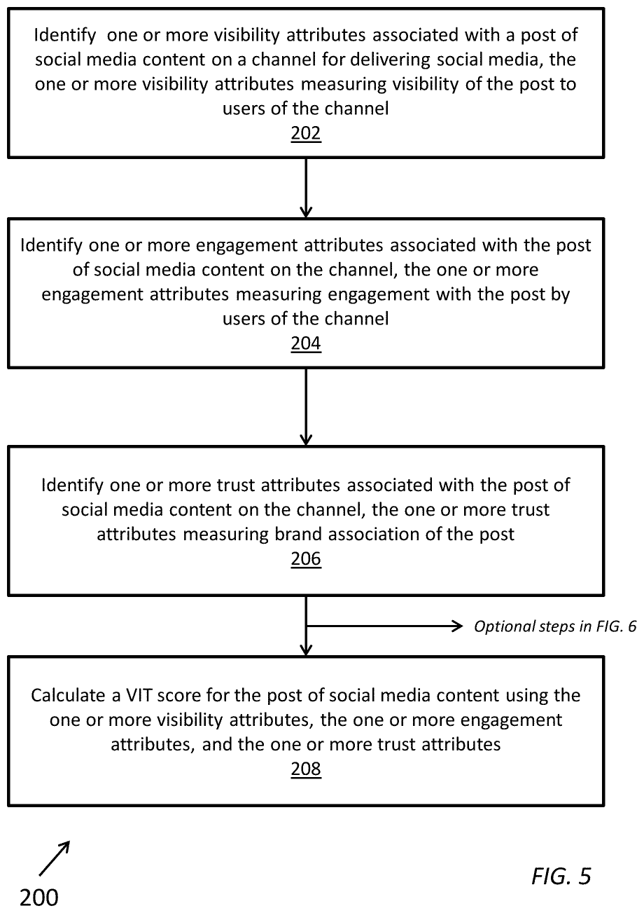

FIG. 5 is a flowchart of a sequence of steps for determining the VIT score for a post of social media content in an exemplary embodiment. The method 200 includes the VIT determination module identifying one or more visibility attributes from retrieved data associated with a post of social media content on a channel for delivering social media. The visibility attributes measure visibility of the post to users of the channel (step 202). For example, the visibility attributes 110 can include raw views or views modified by the repeat factor. The method 200 also includes the VIT determination module identifying one or more engagement attributes from retrieved data associated with the post of social media content on the channel. The engagement attributes measure engagement with the post by users of the channel (step 204). For example, the engagement attributes 120 can include likes, comments, or shares.

The method 200 further includes the VIT determination module 151 identifying one or more trust attributes from retrieved data associated with the post of social media content on the channel. The trust attributes measure a brand association of the post (step 206). For example, the trust attributes 130 can include brand focus, presence of hashtags, overall image content, brand image content, and format of the post of social media content 102. The method 200 also includes the VIT determination module generating a VIT score 105 for the post of social media content using the visibility attributes, the engagement attributes, and the trust attributes (step 208).

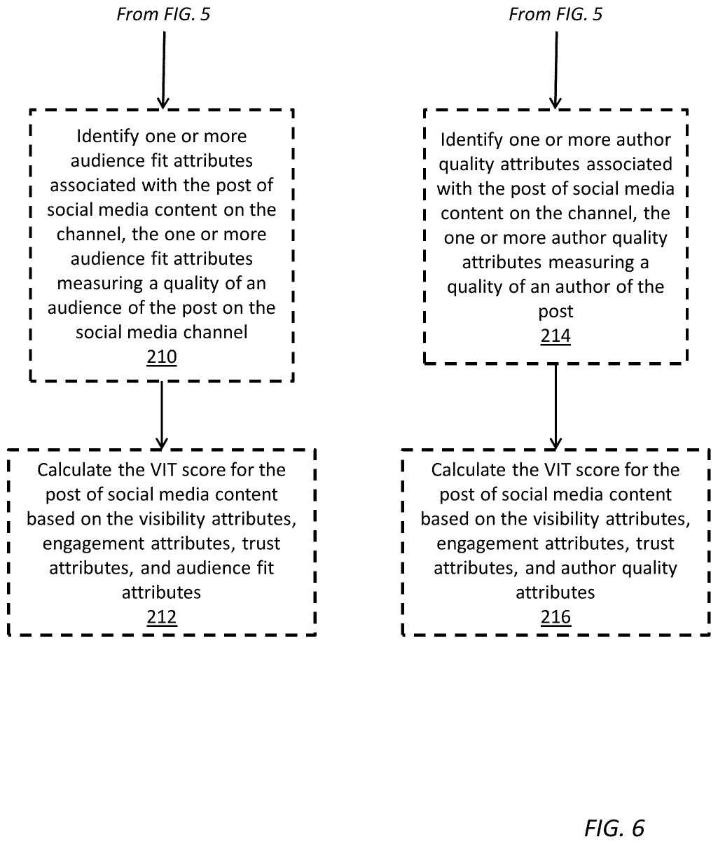

FIG. 6 is a flowchart of a sequence of steps for further optional adjustment of the VIT score from FIG. 5 in an exemplary embodiment. FIG. 6 illustrates further optional adjustment steps in the method 200 performed by the VIT determination module. The method 200 can optionally include the VIT determination module identifying one or more audience fit attributes associated with the post of social media content on the channel. The audience fit attributes measure a quality of an audience of the post on the social media channel (step 210). For example, audience fit attributes can include demographics and psychographics. The method 200 can optionally include generating the VIT score 105 for the post of social media content based on the visibility attributes 110, engagement attributes 120, trust attributes 130, and audience fit attributes 160 (step 212).

Alternatively or in addition to the optional method steps described above, the method 200 can include additional optional method steps. The method 200 can include the VIT determination module identifying one or more author quality attributes associated with the post of social media content on the channel. The author quality attributes measure a quality of an author of the post (step 214). For example, author quality attributes 140 can include average engagement rate and the proportion of real to fake followers. The method 200 can include generating the VIT score 105 for the post of social media content based on the visibility attributes 110, engagement attributes 120, trust attributes 130, and author quality attributes 140 (step 216).

To demonstrate and validate the applicability of VIT score for posts of social media against other measures of visibility and effective reach, VIT scores were generated for a number of posts of social media content 102 for fifteen (15) independent beauty brands based in the United States. The selected beauty brands are influencer-led (i.e., they do little to no other forms of “traditional” marketing), and relevant data from consumer behaviors was accessible. In this test, the relative weights were optimized between posts of social media content 102 from different channels.

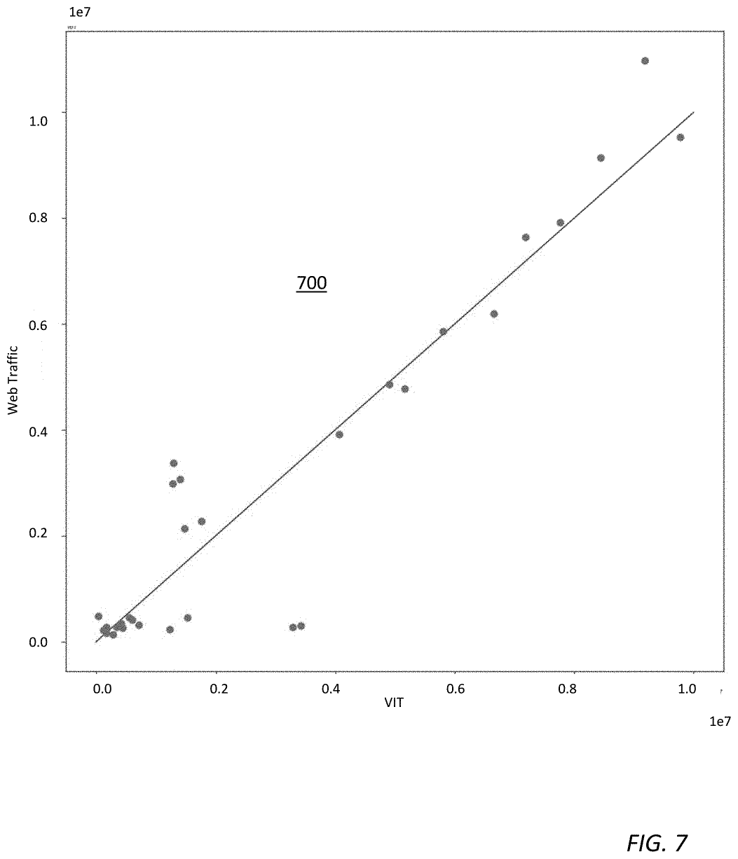

As an example of the utility of the VIT score described herein, FIG. 7 illustrates an plot 700 of web traffic vs. VIT score 105 for posts of social media content. As the plot 700 shows, VIT score 105 is closely linearly correlated with overall web traffic. Here, web traffic was measured over a period of multiple months using a third-party service specializing in assessment of web traffic, i.e., traffic to the website of the brand.

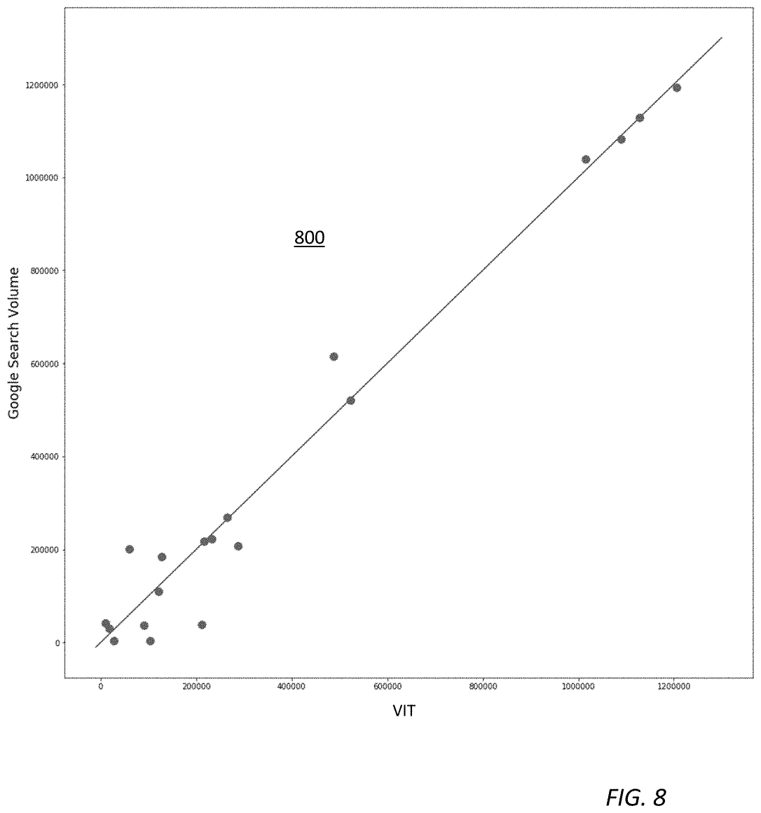

As an additional example of the utility of the VIT score described herein, FIG. 8 illustrates a plot 800 of search volume using the Google® search engine for key terms related to the brand vs. VIT scores 105 for posts related to that brand. As the plot 800 shows, VIT score 105 is closely linearly correlated with overall search volume. Here, Google search volume was measured over a period of multiple months using data received from Google AdWords™. Search volume in this context includes the volume of searches for the brand name.

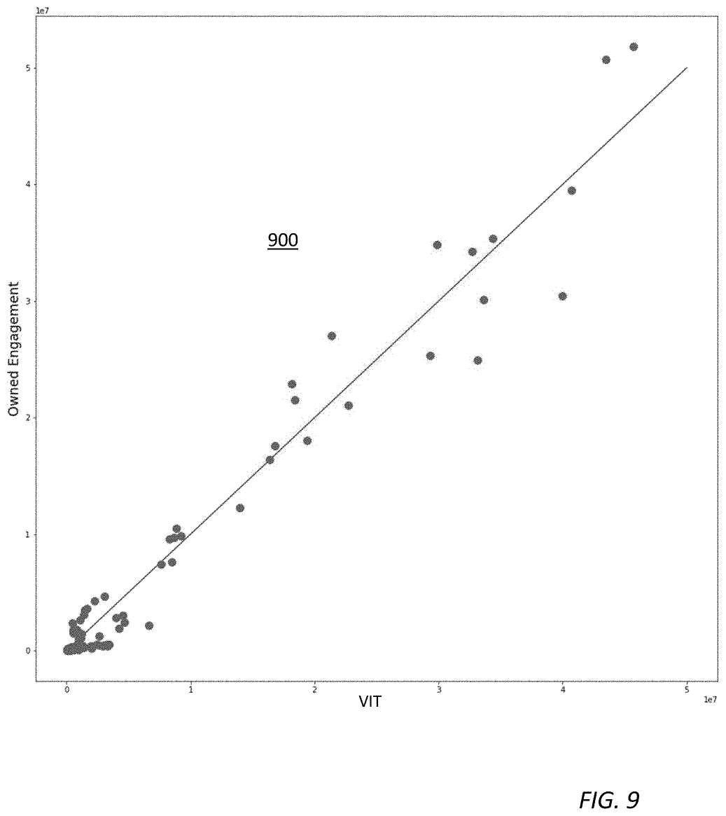

As a further example of the utility of the VIT score described herein, FIG. 9 illustrates a plot 900 of owned engagement vs. VIT score 105. As the plot 900 shows, VIT score 105 is closely linearly correlated with owned engagement, i.e., the level of engagement that the brand gets on corporate-authored posts of social media content. This engagement happening on the brand's social assets includes the sum of likes, retweets, comments (when applicable) and other measures. The information in FIG. 9 was obtained over a period of several months.

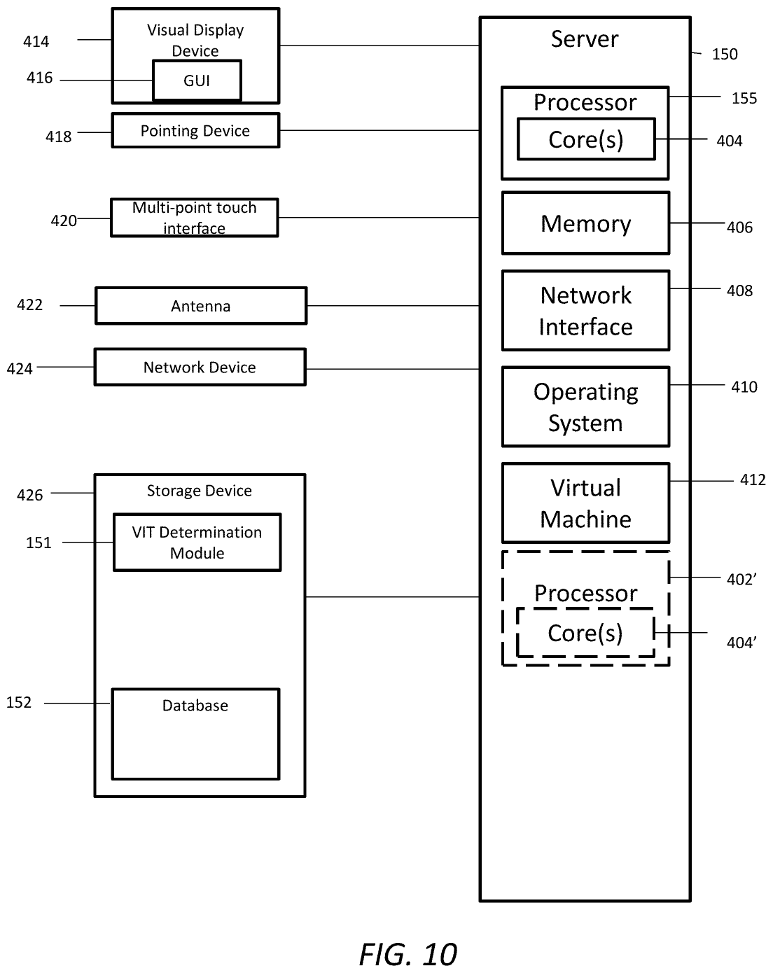

FIG. 10 is a block diagram of an exemplary server 150 (i.e., computing device) suitable for implementing exemplary embodiments of the present disclosure. The server 150 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 406 included in the server 150 may store computer-readable and computer-executable instructions or software for implementing exemplary operations of the server 150. For example, the software can include a VIT determination module 151 retrieved from storage device 426 that is executed to identify visibility attributes 110, engagement attributes 120, or trust attributes 130 or other attributes given a post of social media content 102 and to perform the operations as described above with reference to FIGS. 1-6 in order to generate a VIT score. The software can also be stored in a storage device 426 as described below. The server 150 also includes configurable and/or programmable processor 155 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 406 and other programs for implementing exemplary embodiments of the present disclosure. Processor 155 and processor(s) 402′ may each be a single core processor or multiple core (404 and 404′) processor. Either or both of processor 155 and processor(s) 402′ may be configured to execute one or more of the instructions described in connection with the server 150.

Virtualization may be employed in the server 150 so that infrastructure and resources in the server 150 may be shared dynamically. A virtual machine 412 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, EDO RAM, and the like. Memory 406 may include other types of memory as well, or combinations thereof.

A user may interact with the server 150 through a visual display device 414, such as a computer monitor, which may display one or more graphical user interfaces 416 including graphical user interfaces display a generated VIT score, a multi-point touch interface 420 or a pointing device 418.

The server 150 may also include one or more storage devices 426, such as a hard-drive, CD-ROM, or other computer readable media, for storing data and computer-readable instructions and/or software that implement exemplary embodiments of the present disclosure. For example, exemplary storage device 426 can include a database 152 that can store posts of social media content 102, attributes related to the post of social media content, or attributes related to post authors 101. The database 152 may be updated manually or automatically at any suitable time to add, delete, and/or update one or more data items in the databases.

The server 150 can include a network interface 408 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the server 150 can include one or more antennas 422 to facilitate wireless communication (e.g., via the network interface) between the server 150 and a network. The network interface 408 may include a built-in network adapter, network interface card, PCMCIA network card, card bus network adapter, wireless network adapter, USB network adapter, modem or any other device suitable for interfacing the server 150 to any type of network capable of communication and performing the operations described herein. It will be appreciated that server 150 may communicate over a network with one or more other servers or client devices to transmit the generated VIT scores described herein for further analysis or display.

The server 150 may run any operating system 410, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the server 150 and performing the operations described herein. In exemplary embodiments, the operating system 410 may be run in native mode or emulated mode. In an exemplary embodiment, the operating system 410 may be run on one or more cloud machine instances.

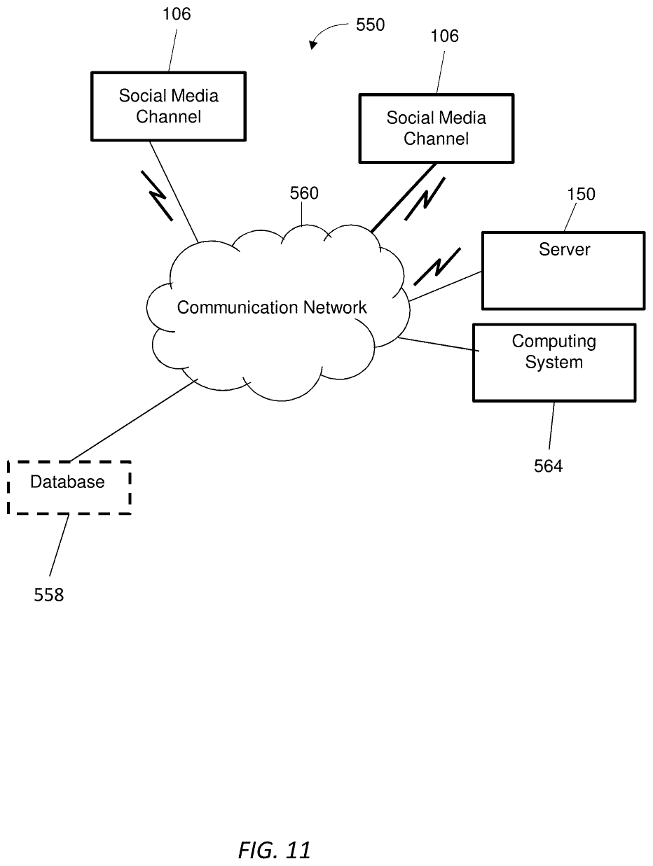

FIG. 11 is a block diagram of an exemplary distributed environment 550 suitable for use with exemplary embodiments of the present disclosure. The environment 550 can include the server 150 configured to be in communication with one or more other computing systems 564 or one or more social media channels 106 via a communication network 560, which can be any network over which information can be transmitted between devices communicatively coupled to the network. For example, the communication network 560 can be the Internet, Intranet, virtual private network (VPN), wide area network (WAN), local area network (LAN), and the like. In some embodiments, the communication network 560 can be part of a cloud environment. The environment 550 can include at least one repository or database 558, which can be in communication with the server 150 and the social media channel or channels 106 via the communications network 560.

In exemplary embodiments, the server 150 and database 558 can be implemented on a stationary computing device or mobile device. Those skilled in the art will recognize that the database 558 can be incorporated into the server 150 such that the server 150 can include the database 558. In some embodiments, the database 558 can include computer-executable instructions or automated scripts that execute to generate VIT score 105.

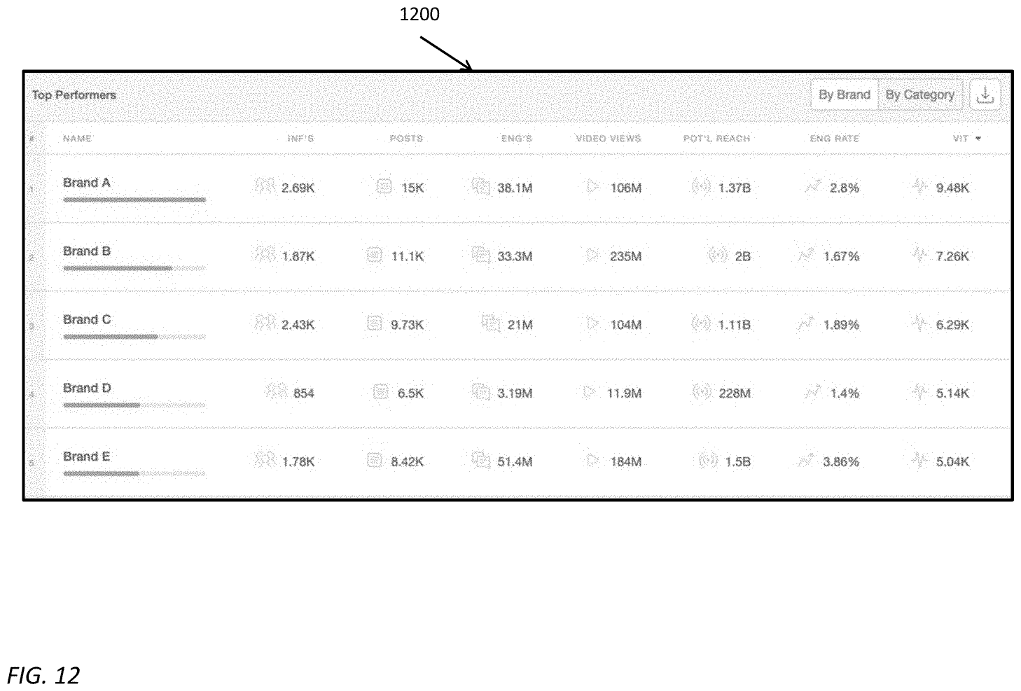

FIG. 12 illustrates a graphical user interface (GUI) displaying total VIT information calculated for several brands in accordance with various embodiments described herein. The GUI 1200 provides information for the marketer related to current total VIT, related to trends with relation to VIT, and related to the underlying information. For example, the GUI 1200 can provide the viewer with total number of authors of posts being tracked (e.g., influencers or “INF'S”) and total number of posts of social media content 102 over the period in question. The GUI 1200 can provide the viewer with the number of engagements and video views. The GUI 1200 can provide the viewer with their potential reach (e.g., the total audience for all of the posts of social media content) and the engagement rate. The GUI 1200 can provide the total VIT 185 for a brand and for other competitor brands. The GUI 1200 provides a simple way to assess performance of a brand's social media outreach relative to competitors.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component, or step. Likewise, a single element, component, or step may be replaced with a plurality of elements, components, or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions, and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

Unless defined otherwise, all technical and scientific terms used herein have the same meaning as commonly understood by one of ordinary skill in the art to which this disclosure belongs. It is also to be understood that the terminology used herein is for the purpose of describing particular embodiments only, and is not intended to be limiting, since the scope of the present disclosure will be limited only by the appended claims. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

1. A computing-device implemented method of determining a metric for brand vitality (VIT) for social media content executed on one or more computing devices equipped with one or more processors, comprising:
executing a VIT determination module on the one or more computing devices, the executing:
identifying one or more visibility attributes from retrieved data associated with a post of social media content on a channel for delivering social media, the one or more visibility attributes measuring visibility of the post to users of the channel, the retrieved data retrieved from one or more of the channel for delivering social media, a third party service providing data regarding the channel for delivering social media and one or more databases of stored attribute information,
identifying one or more engagement attributes from the retrieved data associated with the post of social media content on the channel, the one or more engagement attributes measuring engagement with the post by users of the channel,
identifying one or more trust attributes from the retrieved data associated with the post of social media content on the channel, the one or more trust attributes measuring brand association of the post, and
generating a VIT score for the post of social media content using the one or more visibility attributes, the one or more engagement attributes, and the one or more trust attributes; and
displaying or exporting the generated VIT score.

2. The method of claim 1, further comprising:
identifying one or more audience fit attributes from the retrieved data associated with the post of social media content on the channel, the one or more audience fit attributes measuring a quality of an audience of the post on the social media channel; and
wherein generating the VIT score for the post of social media content further includes using the one or more audience fit attributes.

3. The method of claim 1, further comprising:
identifying one or more author quality attributes from the retrieved data associated with the post of social media content on the channel, the one or more author quality attributes measuring a quality of an author of the post; and
wherein generating the VIT score for the post of social media content further includes using the one or more author quality attributes.

4. The method of claim 1, wherein generating the VIT score for the post of social media content includes summing the one or more visibility attributes and the one or more engagement attributes and multiplying the result by the one or more trust attributes.

5. The method of claim 1, further comprising:
generating a first total VIT score for a marketing campaign based on the VIT score generated for the post and a plurality of other VIT scores respectively generated for a plurality of other posts of social media content, the post and the plurality of other posts associated with the marketing campaign.

6. The method of claim 5, wherein the plurality of other posts include at least one post on a second social media channel.

7. The method of claim 5, wherein the post is associated with a first brand and further comprising:
generating a second total VIT score for a second brand based on a plurality of other posts of social media content associated with the second brand; and
generating a brand ranking based on the first total VIT score and the second total VIT score.

8. The method of claim 1, further comprising:
generating a VIT score for each of a plurality of other posts of social media content associated with the same author; and
generating an average VIT score for the author based on the VIT score for the post and the VIT scores generated for the plurality of other posts.

9. The method of claim 1, wherein the one or more visibility attributes are based at least in part on a number of views of the post on the channel.

10. The method of claim 9, wherein the number of views is modified by a repeat factor indicative of the number of times a brand is mentioned in posts by the same author over a pre-determined period of time.

11. The method of claim 1, wherein the one or more engagement attributes are indicative of one or more of likes, comments, or shares of the post by users of the channel.

12. The method of claim 11, wherein at least one of the one or more engagement attributes is adjusted by a weighting factor based on pre-determined criteria.

13. The method of claim 1, wherein the one or more trust attributes are indicative of one or more of a number of brands included in the post of social media content, a number of hashtags associated with the post of social media content, a number of photographs or images associated with the post of social media content, or a number of brand logos associated with photographs or images in the post of social media content.

14. The method of claim 2, wherein the one or more audience fit attributes are indicative of demographics and psychographics of an audience of the author.

15. A non-transitory medium holding computer-executable instructions for determining a metric for brand vitality (VIT) for social media content, the instructions when executed on one or more computing devices equipped with one or more processors causing at least one computing device to:
execute a VIT determination module, the executing:
identify one or more visibility attributes from retrieved data associated with a post of social media content on a channel for delivering social media, the one or more visibility attributes measuring visibility of the post to users of the channel, the retrieved data retrieved from one or more of the channel for delivering social media, a third party service providing data regarding the channel for delivering social media and one or more databases of stored attribute information,
identify one or more engagement attributes from the retrieved data associated with the post of social media content on the channel, the one or more engagement attributes measuring engagement with the post by users of the channel,
identify one or more trust attributes from the retrieved data associated with the post of social media content on the channel, the one or more trust attributes measuring a brand association of the post, and
generate a VIT score for the post of social media content using the one or more visibility attributes, the one or more engagement attributes, and the one or more trust attributes; and
display or export the generated VIT score.

16. The medium of claim 15, wherein the instructions when executed further cause the at least one computing device to:
identify one or more audience fit attributes from the retrieved data associated with the post of social media content on the channel, the one or more audience fit attributes measuring a quality of an audience of the post on the social media channel; and
wherein generating the VIT score for the post of social media content further includes using the one or more audience fit attributes.

17. The medium of claim 15, wherein the instructions when executed further cause the at least one computing device to:
identify one or more author quality attributes from the retrieved data associated with the post of social media content on the channel, the one or more author quality attributes measuring a quality of an author of the post; and
wherein generating the VIT score for the post of social media content further includes using the one or more author quality attributes.

18. The medium of claim 15, wherein generating the VIT score for the post of social media content includes summing the one or more visibility attributes and the one or more engagement attributes and multiplying the result by the one or more trust attributes.

19. The medium of claim 15, wherein the instructions when executed further cause the at least one computing device to:
generate a first total VIT score for a marketing campaign based on the VIT score generated for the post and a plurality of other VIT scores respectively generated for a plurality of other posts of social media content, the post and the plurality of other posts associated with the marketing campaign.

20. The medium of claim 19, wherein the plurality of other posts include at least one post on a second social media channel.

21. The medium of claim 19, wherein the post is associated with a first brand, and wherein the instructions when executed further cause the at least one computing device to:
generate a second total VIT score for a different brand based on a plurality of other posts of social media content associated with the different brand; and
generate a brand ranking based on the first total VIT score and the second total VIT score.

22. The medium of claim 15, wherein the instructions when executed further cause the at least one computing device to:
generate a VIT score for each of a plurality of other posts of social media content associated with the same author; and
generate an average VIT score for the author based on the VIT score for the post and the VIT scores generated for the plurality of other posts.

23. The medium of claim 15, wherein the one or more visibility attributes are based at least in part on a number of views of the post on the channel.

24. The medium of claim 23, wherein the number of views is modified by a repeat factor indicative of the number of times a brand is mentioned in posts by the same author over a pre-determined period of time.

25. The medium of claim 15, wherein the one or more engagement attributes are indicative of one or more of likes, comments, or shares of the post by users of the channel.

26. The medium of claim 25, wherein at least one of the one or more engagement attributes is adjusted by a weighting factor based on pre-determined criteria.

27. The medium of claim 15, wherein the one or more trust attributes are indicative of one or more of a number of brands included in the post of social media content, a number of hashtags associated with the post of social media content, a number of photographs or images associated with the post of social media content, or a number of brand logos associated with photographs or images in the post of social media content.

28. The medium of claim 15, wherein the one or more audience fit attributes are indicative of demographics and psychographics of an audience of the author.

29. A system for determining a metric for brand vitality (VIT) for social media content, comprising:
a computing device including a processor and a memory operatively coupled to the processor, the memory having instructions stored therein that when executed by the processor cause the computing device to:
identify one or more visibility attributes from retrieved data associated with a post of social media content on a channel for delivering social media, the one or more visibility attributes measuring visibility of the post to users of the channel, the retrieved data retrieved from one or more of the channel for delivering social media, a third party service providing data regarding the channel for delivering social media and one or more databases of stored attribute information;
identify one or more engagement attributes from the retrieved data associated with the post of social media content on the channel, the one or more engagement attributes measuring engagement with the post by users of the channel;
identify one or more trust attributes associated from the retrieved data with the post of social media content on the channel, the one or more trust attributes measuring a brand association of the post; and
generate a VIT score for the post of social media content using the one or more visibility attributes, the one or more engagement attributes, and the one or more trust attributes.

30. The system of claim 29, wherein the memory has further instructions stored therein that when executed by the processor cause the computing device to:
identify one or more audience fit attributes from the retrieved data associated with the post of social media content on the channel, the one or more audience fit attributes measuring a quality of an audience of the post on the social media channel; and
wherein generating the VIT score for the post of social media content further includes using the one or more audience fit attributes.

31. The system of claim 29, wherein the memory has further instructions stored therein that when executed by the processor cause the computing device to:
identifying one or more author quality attributes from the retrieved data associated with the post of social media content on the channel, the one or more author quality attributes measuring a quality of an author of the post; and
wherein generating the VIT score for the post of social media content further includes using the one or more author quality attributes.

32. The system of claim 29, wherein generating the VIT score for the post of social media content includes summing the one or more visibility attributes and the one or more engagement attributes and multiplying the result by the one or more trust attributes.

33. The system of claim 29, wherein the memory has further instructions stored therein that when executed by the processor cause the computing device to:
generate a first total VIT score for a marketing campaign based on the VIT score generated for the post and a plurality of other VIT scores respectively generated for a plurality of other posts of social media content, the post and the plurality of other posts associated with the marketing campaign.

34. The system of claim 33, wherein the plurality of other posts include at least one post on a second social media channel.

35. The system of claim 33, wherein the post is associated with a first brand and wherein the memory has further instructions stored therein that when executed by the processor cause the computing device to:
generate a second total VIT score for a different brand based on a plurality of other posts of social media content associated with the different brand; and
generate a brand ranking based on the first total VIT score and the second total VIT score.

36. The system of claim 29, wherein the memory has further instructions stored therein that when executed by the processor cause the computing device to:
generating a VIT score for each of a plurality of other posts of social media content associated with the same author; and
generating an average VIT score for the author based on the VIT score for the post and the VIT scores generated for the plurality of other posts.

37. The system of claim 29, wherein the one or more visibility attributes are based at least in part on a number of views of the post on the channel.

38. The system of claim 37, wherein the number of views is modified by a repeat factor indicative of the number of times a brand is mentioned in posts by the same author over a pre-determined period of time.

39. The system of claim 29, wherein the one or more engagement attributes are indicative of one or more of likes, comments, or shares of the post by users of the channel.

40. The system of claim 39, wherein at least one of the one or more engagement attributes is adjusted by a weighting factor based on pre-determined criteria.

41. The system of claim 29, wherein the one or more trust attributes are indicative of one or more of a number of brands included in the post of social media content, a number of hashtags associated with the post of social media content, a number of photographs or images associated with the post of social media content, or a number of brand logos associated with photographs or images in the post of social media content.

42. The system of claim 29, wherein the one or more audience fit attributes are indicative of demographics and psychographics of an audience of the author.
